(19) United States
(12) Patent Application Publication
(10) Pub. No.: US 2024/0186776 A1
(43) Pub. Date: Jun. 6, 2024

(54) Safety Outlet Cover

(71) Applicant: Evester Noble Simmons, Florissant, MO (US)

(72) Inventor: Evester Noble Simmons, Florissant, MO (US)

(73) Assignee: Evester Noble Simmons, Florissant, MO (US)

(21) Appl. No.: 18/119,756

(22) Filed: Mar. 9, 2023

Related U.S. Application Data
(60) Provisional application No. 63/318,035, filed on Mar. 9, 2022.

(51) Int. Cl. H02G 3/08

(52) U.S. Cl. CPC H02G 3/081

(57) ABSTRACT

The invention disclosed herein relates to a device and method of use for the safety and security of electrical outlets. The apparatus may be used to protect against unauthorized use of the outlet and guard children and pets against accidental harm from an electric current of an electrical outlet. The device may include an apparatus for covering electric outlets comprising a cover and at least one secure portal system, wherein the cover is detachably attached to the electrical outlet; wherein the secure portal system comprises at least one accessible-inaccessible gateway with a lockable system, a pressure device, and an enterable tunnel. The apparatus requires a pressure-modulation tool to access the locked accessible-inaccessible gateway for an electrical socket.

### CROSS-REFERENCE TO RELATED APPLICATIONS

None

Application is a Non-Provisional Application claiming priority of the Provisional U.S. Application No. 63/318,035 filed on 9 Mar. 2022 and is incorporated in its entirety herein

### STATEMENT REGARDING FEDERALLY SPONSORED RESEARCH OR DEVELOPMENT

Not applicable.

The present disclosure relates to an apparatus for covering electrical and electronic outlets, wherein the covers may be for the purposes of a child or pet safety. The cover may also be used for securing wall devices from theft. The disclosure herein also details methods of making and using the said apparatus.

### BACKGROUND

The public will benefit from the invention disclosed herein because it relates to the safety and security of electrical/electronic devices from theft and harming of children and pets.

### BRIEF DESCRIPTION OF THE INVENTION

This application relates to an apparatus and method of using a safety apparatus for an electrical outlet in homes, commercial places, kindergartens, other places. The apparatus may be utilized where crawling infants, toddlers, children, animals, pets, etc., may be prone to accidental exposure to dangerous and damaging electrical outlets and electrical shocks.

A prominent feature of the apparatus is that it may be used for the electrical outlet function while providing safety features. The safety feature will remain intact while the outlet is in use.

In some embodiments, the techniques described herein relate to an apparatus for covering electric outlets including a cover and at least one secure portal system, wherein the cover is detachably attached to the electrical outlet; wherein the secure portal system includes at least one accessible-inaccessible gateway with a lockable system, a pressure device, and an enterable tunnel.

In some embodiments, wherein the apparatus can replace a conventional electrical outlet.

In some embodiments, the techniques described herein relate to an apparatus, wherein the pressure device includes a pressure-creating device, a pressure-modulation device, a pressure-modulating tool, and a pressure-transmitter device.

In some embodiments, wherein the pressure-creating device may be a mechanical compression spring made of steel music wire with 12.5 total coils and closed ends, an O.D. of 0.188 inches, an I.D. of 0.154 inches, and a spring rate of 2.3 inch pounds.

In some embodiments, wherein the cover includes a frame, a plate, a centrally located balancer, and at least one circuit bracer, and wherein the bracer is located on at least one side of the gateway.

In some embodiments, wherein the bracer fits with any conventional outlet socket, and wherein the bracer is configured to attach the cover stably and securely to a wall electrical outlet.

In some embodiments, wherein the balancer is configured to attach stably and securely cover to any electric wall outlet, wherein the balancer is configured for correct electrical circuit function without disruption of the electrical circuit.

In some embodiments, wherein the balancers contain a 0.5-inch long balancer screw within the center of the balancer or balancer-hole.

In some embodiments, wherein the lockable system includes at least one hinge, at least one hinge-link, at least one hook-trap, at least one hook-handle, at least one eye, at least one eye-catcher, at least one inner eye-catcher, and at least one pressure-sensitive movable button, wherein the hinge when the accessible-inaccessible gateway door is in an inaccessible position, is covering, shielding, or conceling and is over the pressure-sensitive movable button.

In some embodiments, wherein the pressure-sensitive movable button is contained within a opening-link.

In some embodiments, wherein the enterable tunnel has two ends, a first end and a second end, wherein the first end has a tunnel entrance, and the second end has the pressure-modulating device.

In some embodiments, wherein the enterable tunnel is available for the pressure-modulating tool to enter the tunnel to alter/reduce the pressure-creating device's pressure through the pressure-modulating device.

In some embodiments, wherein the pressure device includes a pressure modulation device connected to a pressure transmitter device, wherein the pressure transmitter device communicates an alternation in pressure, wherein the communication is selected from a group consisting of mechanical, analog, digital, wired, wireless, and any combination thereof.

In some embodiments, wherein the pressure transmitter device communicates an alternation in pressure to a pressure-sensitive movable button of the lockable system.

In some embodiments, wherein the pressure transmitter device communicates an alternation in pressure to the lockable system.

In some embodiments, wherein the pressure-creating device is connected to a lockable system, wherein the pressure modulation tool through the tunnel is configured to modulate the pressure of the pressure-creating device, wherein the pressure-creating device transmits pressure alternations to the lockable system, and wherein the lockable system is further configured to open the inaccessible gateway.

In some embodiments, wherein the pressure modulation tool through the tunnel is configured to modulate the pressure generated by the pressure-creating device, wherein the pressure-creating device transmits pressure any pressure alternations to the pressure-sensitive movable button, and wherein the movable button is further configured to open the accessible-inaccessible gateway.

In some embodiments, the apparatus may have an electrical light, wherein the light may be motion and/or light-sensitive. A disposable battery, rechargeable battery, solar battery, and any combination thereof may power the light. The light bulb may be conventional or incandescent, fluorescent, compact fluorescent, halogen, LED, or any combination thereof.

In some embodiments, the techniques described herein relate to a method for covering electric outlets including a cover and at least one secure portal system, wherein the cover is detachably attached to the electrical outlet; wherein the secure portal system includes at least one accessible-inaccessible gateway with a lockable system with an inner eye-catcher, a pressure device, and an enterable tunnel, and including of steps: (i) a pressure modulation tool is inserted into the enterable tunnel, (ii) pressure modulation device alters pressure created by pressure creating device, (iii) the altered pressure is communicated by the pressure-transmitting device, (iv) the altered pressure is transmitted to the lockable system, (v) the unleashing the of hook-trap from the inner eye-catcher of the lockable system, (vi) the gateway door becomes unlocked, and (vii) the gateway doors open.

In some embodiments, the techniques described herein relate to a method for covering electric outlets including a cover and at least one secure portal system, wherein the cover is detachably attached to the electrical outlet; wherein the secure portal system includes at least one accessible-inaccessible gateway with a lockable system with pressure-sensitive movable button, a pressure device, and an enterable tunnel, and including of steps: (v) a pressure modulation tool is inserted into the enterable tunnel, (vi) pressure modulation device alters pressure created by pressure creating device, (vii) the altered pressure is communicated by the pressure transmitting device, (viii) the altered pressure is transmitted to the pressure-sensitive movable button, (ix) the movable button moves to release pressure on the gateway door hinges, and (x) the gateway door open.

In some embodiments, the techniques described herein relate to an electrical outlet safety apparatus including at least one lockable door configured to access the outlet and a cover configured to be de-attachably attached to the outlet faceplate. In some embodiments, wherein the lockable door includes at least one lockable door, a pressure-creating device, a pressure-modulating tool, and an enterable tunnel with two ends, wherein a first tunnel end is available for the pressure-modulating tool to enter into the tunnel, and the pressure-creating device is at a second end of an enterable tunnel, wherein the pressure modulation tool through the tunnel is configured to modulate the pressure of the pressure creating device, wherein the pressure creating device is connected to the lockable the door, and wherein the pressure modulation is further configured to lock-unlock the door

In an embodiment, the apparatus may contain hinged one, two, three, four, five, six, or more gateway doors.

In an embodiment, the apparatus/frame/cover may be rectangular, square, round, oval, or any other shape that can cover the electrical outlet, especially one or more sockets, internet access ports, USP ports, etc.

### BRIEF DESCRIPTION OF THE FIGURES

FIG. 1 shows a front view of the outlet cover with a gateway door in an accessible position. The gateway comprises at least one door and an opening corresponding to the door.

FIG. 2 shows a front view of the outlet cover with a gateway door in an inaccessible position.

FIG. 3 shows a back view of the outlet cover with a gateway door in an accessible position.

FIG. 4 shows a back view of the outlet cover with a gateway door in an accessible position with a pressure-creating device, a pressure-detecting device, a pressure-transmitting device, and a lockable system.

FIG. 5 shows a pressure-device and lockable system: The pressure device is made of a pressure-creating device, a pressure-modulation device, and a pressure-transmitting device.

FIG. 6 shows gateway door views.

FIG. 7 shows all components of the apparatus.

FIG. 8 is a flowchart of an example method for covering electric outlets with a lockable system.

FIG. 9 is a flowchart of an example method for covering electric outlets using a pressure-sensitive movable button.

### DETAILED DESCRIPTION OF THE INVENTION

Examples of embodiments are provided so that this disclosure will be thorough and fully convey the scope to those skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

As used herein, the term “electrical outlet” means any outlet supplying electrical current through connection to electrical output capable of impacting electrical shock to a human or animal.

This application relates to an electrical or electronic theft, child, and pet safety outlet apparatus and the apparatus's method of use. The apparatus may be used as a safety apparatus for any electrical and like outlets. In addition, this apparatus may be used as a safety cover for an electrical outlet in homes, commercial places, kindergartens, schools, etc., and any combination thereof. People and businesses lose financial resources due to theft from electrical or electronic outlets. Additionally, crawling infants, toddlers, children, animals, pets, etc., may be prone to accidental exposure to dangerous and damaging electrical outlets and get electrical shocks.

The main feature of the apparatus of this disclosure is that it may be used as an electrical outlet while still providing safety features. The safety feature will remain intact while the outlet is in use. The apparatus entails an outlet cover frame configured to cover the electrical connections, such as sockets, etc. The apparatus may further comprise one or more gateway doors that provide assess to the outlet for use.

In some embodiments, the techniques described herein relate to an apparatus for covering electric outlets, including a cover and at least one secure portal system, wherein the cover is detachably attached to the electrical outlet; wherein the secure portal system includes at least one accessible-inaccessible gateway with a lockable system, a pressure device, and an enterable tunnel.

In some embodiments, the apparatus can replace and/or add to a conventional electrical or electronic outlet.

In some embodiments, the techniques described herein relate to an apparatus wherein the pressure-device includes a pressure-creating device, a pressure-modulation device, a pressure-modulating tool, and a pressure-transmitter device.

In some embodiments, wherein the pressure creating device may be a mechanical compression spring make of steel music wire with 12.5 total coils and closed ends, an O.D. of 0.188 inches, an I.D. of 0.154 inches, and a spring rate of 2.3 inch pounds.

In some embodiments, wherein the cover includes a frame, a plate, a centrally located balancer with a balancer hole capable of fitting a balancer screw, and at least one circuit bracer.

In some embodiments, wherein the bracer is located on at least one side of the gateway, for example one, two, three, four or any fraction side thereof

In some embodiments, wherein the bracer fits with any conventional outlet socket, and wherein the bracer is configured to attach the cover stably and securely to a wall electrical outlet.

In some embodiments, wherein the balancer is configured to attach stably and securely cover to any electric wall outlet.

In some emboiments, wherein the balancer is configured for correct electrical circuit function without disruption of the electrical circuit.

In some embodiments, wherein the balancers contain a 0.5-inch long balancer screw within it.

In some embodiments, wherein the lockable system includes at least one hinge, at least one hinge-link, at least one hook, at least one hook-trap, at least one hook-handle, at least one eye, at least one eye-catcher, at least one inner eye-catcher, at least one trap body, at least one hook-catcher, at least one hook entrance, at least one opening-link, and at least one pressure-sensitive movable button.

In some embodiments, the apparatus may have an electrical light, wherein the light may be motion and/or light-sensitive. A disposable battery, rechargeable battery, solar battery, and any combination thereof may power the light. The light bulb may be conventional or incandescent, fluorescent, compact fluorescent, halogen, LED, or any combination thereof.

In some embodiments, wherein the apparatus may have at least one lockable system, for example, 1, 3, 4, 6, 7, 8, 9, 10 lockable systems for every apparatus.

I some embodiments, wherein the hinge, when the accessible-inaccessible gateway door is in an inaccessible position, covers, shields, conceals, and lays over the pressure-sensitive movable button.

In some embodiments, wherein the pressure-sensitive movable button is within contained within an opening-link, which may also contain a pressure device and any part of a pressure device.

In some embodiments, the opening-link may also have a pressure-creating, pressure-transmitters, pressure receiver, and any combination thereof. The pressure receiver is capable of receiving pressure alternation data/signal/communication from the transmitter.

In some embodiments, wherein the enterable tunnel has two ends, a first end and a second end, wherein the first end has a tunnel entrance, and the second end has the pressure-modulating device. The second end may have a connector to the pressure-modulating device.

In some embodiments, wherein the enterable tunnel is available for the pressure-modulating tool to enter the tunnel to alter/reduce/increase the pressure-creating device's pressure through the pressure-modulating device. The modulating tool may be customizable similar to a lock and key; thus, the pressure-modulating tool may be similar to a key, and the pressure-modulator device or a connection to the pressure-modulating device may be similar to a lock such that each tool functions for its counterpart and specific pressure-modulating device and not other pressure modulating devices.

In some embodiments, wherein the pressure device includes a pressure modulation device connected to a pressure transmitter device, wherein the pressure transmitter device communicates an alternation (reduction/increase) in pressure, wherein the communication is selected from a group consisting of mechanical, analog, digital, wired, wireless, and any combination thereof.

In some embodiments, wherein the pressure transmitter device communicates an alternation (increase or reduce) in pressure to a pressure-sensitive movable button of the lockable system. The communication may be via a pressure transmitter that may be contained within the opening-link or another location. The transmitter may or may not be linked directly or indirectly to a pressure receiver.

In some embodiments, wherein the pressure transmitter device communicates an alternation in pressure to the lockable system.

In some embodiments, wherein the pressure-creating device is connected to a lockable system, wherein the pressure modulation tool through the tunnel is configured to modulate the pressure of the pressure-creating device, wherein the pressure-creating device transmits pressure alternations (reduce/increase) to the lockable system, and wherein the lockable system is further configured to open the inaccessible gateway.

In some embodiments, wherein the pressure modulation tool through the tunnel is configured to modulate the pressure generated by the pressure-creating device, wherein the pressure-creating device transmits pressure any pressure alternations (increase/reduce) to the pressure-sensitive movable button, and wherein the movable button is further configured to open the accessible-inaccessible gateway.

In some embodiments, the techniques described herein relate to a method for covering electric outlets, including a cover and at least one secure portal system, wherein the cover is detachably attached to the electrical outlet; wherein the secure portal system includes at least one accessible-inaccessible gateway with a lockable system with an inner eye-catcher, a pressure device, and an enterable tunnel, and including of steps: (i) a pressure modulation tool is inserted into the enterable tunnel, (ii) pressure modulation device alters pressure created by pressure creating device, (iii) the altered pressure is communicated by the pressure-transmitting device, (iv) the altered pressure is transmitted to the lockable system, (v) the unleashing the of hook-trap from the inner eye-catcher of the lockable system, (vi) the gateway door becomes unlocked, and (vii) the gateway doors open.

In some embodiments, the techniques described herein relate to a method for covering electric outlets, including a cover and at least one secure portal system, wherein the cover is detachably attached to the electrical outlet; wherein the secure portal system includes at least one accessible-inaccessible gateway with a lockable system with pressure-sensitive movable button, a pressure device, and an enterable tunnel, and including of steps: (i) a pressure modulation tool is inserted into the enterable tunnel, (ii) pressure modulation device alters pressure created by pressure creating device, (iii) the altered pressure is communicated by the pressure transmitting device, (iv) the altered pressure is transmitted to the pressure-sensitive movable button, (v) the movable button moves to release pressure on the gateway door hinges, and (vi) the gateway door open.

In some embodiments, the techniques described herein relate to an electrical outlet safety apparatus including at least one lockable gateway door configured to access the outlet and a cover configured to be de-attachably attached to the electrical outlet with or without a faceplate.

In some embodiments, wherein the lockable gateway door includes at least one lockable door, a pressure-creating device, a pressure-modulating tool, and an enterable tunnel with two ends, wherein a first tunnel end is available for the pressure-modulating tool to enter into the tunnel, and the pressure-creating device is at a second end of an enterable tunnel, wherein the pressure modulation tool through the tunnel is configured to modulate the pressure of the pressure creating device, wherein the pressure creating device is connected to the lockable the gateway door, and wherein the pressure modulation is further configured to lock-unlock the door

In some embodiments, the apparatus may contain one or more gateway doors, for example, 1, 2, 3, 4, 5, 6, 7, 8, 9, or 10 doors.

In some embodiments, the gateway doors may be attached, detachably attached, and/or detached.

In an embodiment, the gateway door may be attached or detachably attached may be via hinges slip-on, interlocking, bendable, permanent or temporary glues, Velcro, suction cups, clip-on, magnets, screwed-in, glide-in, slick-on, slide-in, etc., or any combination thereof.

In some embodiments, the gateway door may cover one or more sockets, for example, 1, 2, 3, 4, 5, 6, 7, 8, 9, and 10 sockets.

In some embodiments, the gateway door size may be of a width of 0.5 to 4 inches, for example, 1 and ⅛ inches, and the length of 1 to 5 inches, for example, is 2.0 and ½ inches.

In some embodiments, the gateway door may be locked and/or unlocked via a latching mechanism, hook-eye mechanism, hook-catchers, springs, the release of the key, button, hinges, slip-on, interlocking, bendable, permanent or temporary glues, Velcro, suction cups, clip-on, magnets, screwed in, glide-in, slick-on, slide-in, etc., or any combination thereof.

In some embodiments, the gateway door may be opened via the press of a button, key release mechanism, pressure modulation tool, remote-control, hook-eye, hook-catcher, springes, via hinges, slip-on, interlocking, bendable, permanent or temporary glues, Velcro, suction cups, clip-on, magnets, screwed in, glide-in, slick-on, slide-in, etc., or any combination thereof.

In some embodiments, the gateway door may be square, rectangle, triangle, circular, oval, etc.

In some embodiments, the gateway door may be made of any electrically inactive material such as plastics, synthetic material, natural material, rubber, etc., or any combination thereof.

In some embodiments, the cover frame and plate may be rectangular, square, round, oval, or any other shape that can cover the electrical outlet, especially one or more sockets, internet access ports, USP ports, etc.

In some embodiments, the apparatus /cover may be attached to the outlet faceplate.

In some embodiments, the apparatus /cover may replace the outlet faceplate.

In some embodiments, the apparatus/cover may be an addition to the outlet faceplate.

In some embodiments, the apparatus/cover may be similar in size to a standard faceplate.

In some embodiments, the apparatus/cover doors may be opened and closed using a spring-activated locking bar.

In some embodiments, the apparatus/cover may be made of any electrically inactive or neutral materials, for example, plastics, natural material, artificial material, synthetic materials, rubber, etc., and any combination thereof.

In some embodiments, the apparatus/cover may be separated from the outlet face plate by 1, 2, 4, 5, 6, 7, 8, 9, 10, 11, 12, 13, 14, 15, 16, 17, 18, 19, 20, 25, 30, 35 centimeters.

In some embodiments, the apparatus/cover may be attached or detachably attached to the outlet faceplate via hinges slip-on, interlocking, bendable, permanent or temporary glues, Velcro, suction cups, clip-on, magnets, screwed-in, glide-in, slick-on, slide-in, snap-on, etc., prongs insertable or non-insertable into the sockets, or any combination thereof.

In some embodiments, the apparatus or a part thereof may be of a variety of colors, for example, red, blue, green, yellow, white, black, etc., and any combination thereof.

In some embodiments, the apparatus or a part thereof may form a decorative design in an embodiment. The design may hide or disguise one or more features of the apparatus.

In some embodiments, the apparatus or a part thereof has one or more mechanisms for opening, closing, locking the door(s), for example, grooves, holes, adhesive strips, a place for adhesives, Velcro, suction cups, magnets, clips, hinges, interlocking mechanisms, screws, snap-on, prongs insertable or non-insertable into the sockets, etc., or any combination of thereof

In some embodiments, the mechanism for opening, closing, locking the doors may be one front side (away from the socket), the backside (facing the socket), or both.

In some embodiments, the opening, closing, locking may require additional tools and equipment, such as a remort-control, key, pin, prong, tab, another mechanical device, etc., or any combination thereof.

In some embodiments, the mechanism for opening, closing, locking the doors may be disguisable, concealed, or hidden.

In some embodiments, the opening, closing, and/or locking mechanisms may be squares, rectangles, circles, oval, etc., or any combination thereof.

In some embodiments, the hidden squared, rectangles, circles, ovals, etc., structures may further comprise keys, buttons, tabs, etc., to open, close, lock the doors, or any combination thereof.

In some embodiments, the gateway doors may be lockable or unlockable shutters.

In some embodiments, the gateway doors may be on the front side, backside, or both.

In some embodiments, the gateway doors may open towards, from side, backside, sideways, or any combination thereof

In some embodiments, the gateway doors may be the same or different color and material than the other parts of the apparatus, conventional electrical outlet or any combination thereof.

In some embodiments, the backside of the apparatus/cover frame may comprise additional safety structures or processes, for example, flexible, stretchable, bendable, ruffled, gride, layers, lids, etc., or any combination thereof.

In some embodiments, the backside structures may be made of plastics, rubber, synthetic material, natural material, artificial materials, etc., or any combination thereof

In some embodiments, the backside and/ or frontside may further comprise gadgets for additional functions, for example, safely storing electrical chords, electrical or pressure shock absorbers, USB ports, storage for tools, and or accessories, attachment for charging station, which may be wired or wireless charging, etc., or any combination thereof.

In some embodiments, the plate may have a central balancer [1], which may be a central hole for a balancer screw. The balancer's design [1] may be such that the balancer screw within it may not be too tight or loose. Thus, the balancer may assist the outlet cover in securely and stably attaching the cover to a wall with the electric outlet. Additionally, when the balancer screw is too tight, it may disrupt and hinder the electrical circuit function; the bracer may prevent the bracer screw from going deep and tight into a circuit. Without the screw balancer, it may go too deep and push in the faceplate, affecting the gateway doors and altering (reducing) the pressure. The pressure-creating device may not create adequate pressure for the apparatus's proper functions. Therefore, properly functioning the gateway doors requires the balancer and the balancer screws to function correctly. The balancer also stably secures the outlet cover over the electrical outlet.

In some embodiments, the balancer screw may be up to 2 inches long, for example, 0.4, 0.5, 0.6. 0.7. 0.75. 0.8, 0.9, 1, 1.2, 1.3, 1.4, 1.5, 1.6, 1.7, 2.8, 2.9, 2 inches long.

In some embodiments, the bracer may be present on one, two, three, or four sides, the gateway opening, or any fraction thereof. The bracer/s function may be to brace and tighten the cover over an electrical outlet against at least one side, such as the top, bottom, left, or right side outlet, to secure movement stably. The braces may fit with the outlet socket/s. The brace may further assist the apparatus in securely and stably attaching to the wall outlet.

In some embodiments, the entrance tunnel may be lined with straight walls on one, two, three, and four sides creating an entrance tunnel. The entrance tunnel may direct, guide, and lead the pressure modulation tool, for example, a customizable key, to the pressure modulating device, which may be further connected directly or indirectly to the pressure-creating device. Without these walls, the pressure modulating tool may not be able to correctly contact the pressure-creating device, pressure transmitter and/or pressure-modulating device for the apparatus's proper function. In the presence of the walls, when the tool is inserted into the tunnel, it may not make correct contact with the pressure-creating device, pressure transmitter and/or pressure-modulating device. Thus, may incorrectly create, transmit, modulate, or alter the pressure (for example, reduce the pressure), resulting in not or incorrectly opening the gateway door/s.

In some embodiments, the movable button may be located or contained in the opening-link of the lockable gateway system. The movable button may put pressure on the gateway doors. This pressure may cause the gateway doors to unlock and pop open. The movable button releases the pressure causing the door to open immediately. The movable button may be connected to one or more parts of the pressure device, wherein this connection may result in a communication of any pressure alteration caused by the pressure modulation tool.

In some embodiments, the movable button may be connected to the pressure transmitter with or without a receiver. The transmitter may communicate with the movable button by a physical, analog, mechanical manner, or a combination thereof. In an embodiment, the transmitter may communicate with the movable button via a digital manner, which may be wired, wireless, Bluetooth, or both.

In some embodiments, the pressure-creating device may be electronic, mechanical, computerized, etc. The mechanical device may be a spring, for example, a regular compression spring. The spring may be made of steel music wire with up to 15 total coils, for example, 8, 9, 10, 11, 12, 12.5, 13, 14, and 15 coils, and may be closed on one or both ends of the spring may have features such as an O.D. of up to 2 inches, for example, 1, 1.5, 1.6, 1.7, 1.8, 1.88, 1.9, 2 an I.D. of up to 0.16 inches, for example, 0.12, 0.13, 0.14, 0.15, 0.154, 0.155, 0.16 inches and a spring rate of 2.3-inch pounds, for example of 2, 2.1, 2.2,.2.3, 2.4, or 2.5 inches pounds. The electronic and/or computerized pressure-creating device may create a pressure or force of 2, 2.1, 2.2,.2.3, 2.4, or 2.5-inches pounds, and may be up to 2 inches long, for example, 1, 1.5, 1.6, 1.7, 1.8, 1.88, 1.9, 2 inches long, and 0.155 inches wide, for example, 0.12, 0.13, 0.14, 0.15, 0.155, 0.16 inches wide.

In some embodiments, the apparatus/frame/cover may measure with a width of 3 and ¼ inches and a length of 5 inches. The gateway doors width is 1 and ⅛ inches, and the length is 2 and ½ inches. The hinge snaps into eye catcher is circles of 1/16 inches. The handle width is ¼ inches, and the length is ¼ inches. The hook width is ⅛ inch, and the length is ¼ inches. The tunnel entrance has a width of ¼ and a length of ¼ inches. The modulation tool entrance is width ⅜″ and length ⅛ inches. The pressure creating or pressure-creating holder has a width of 1/16 inches and a length of ⅛ inches. The clamp's width is 1/16″ and length 4/16 inches. The hook catch width is ⅛ inch and length 1/16 inch. The trap body width is ⅜ inches and a length of 4 inches and ⅛ inches. The pressure modulating tool has a width of ⅜ inches and a length of ⅛ inches. The straight-wall width is ⅛ inch and length 1 inch. The pressure-sentive movable button is 24 inches wide and 1/16 inch in length; the balancer-screw balancer is 2/16 inch long; bracer 3/16 long and one and ¼ long; the entrance tunnel wall is ⅜ wide and ¼ long; the straight walls 1 inch long and 3/16 tall; tool entrance ⅞ wide and 3/16 long.

### EXAMPLES

Comparative testing of the apparatus of the disclosure herein with the U.S patent application No. US2009188693A shows the following:

Stability of the attachment to an electrical outlet wall as a replacement of the conventional faceplate. The stability was measured as visible movement and/or remaining attached during use. The apparatus of the disclosure herein showed 99% or more stability for all apparatus tested, and every time the apparatus was used, and the apparatus remained attached without any noticeable movement. The apparatus of the U.S patent application No. US2009188693A had a less than 10% stability for all the apparatus tested, and every time the apparatus was used. Either the apparatus moved and/or did not remain attached.

Disruption of function as the socket not correctly working or detachment due to the balancer screw. The apparatus of the disclosure herein never disrupted the outlet's functioning and never disrupted the apparatus's attachment to the wall. However, the apparatus of the U.S. patent application No. US2009188693A disruption of the electrical outlet 50% of the times used; no current was observed in the connected electrical bulb, suggesting outlet function disruption and damage to the outlet's electrical circuit. Additionally, 90% failed attempts to attach when the apparatus of the U.S. patent application No. US2009188693A was used. It did not attach correctly, resulting in movement and detachment from the wall outlet.

Opening the gateway doors or equivalent for using the electrical outlet socks. The apparatus of the disclosure herein showed a 96% correct opening of the gateway doors. The doors for apparatus of the U.S patent application No. US2009188693A only opened the doors correctly less than 10%.

Each of the above tests was done with ten different apparatuses for each disclosure, and each unit was used fifty times.

### Detailed Figure Description

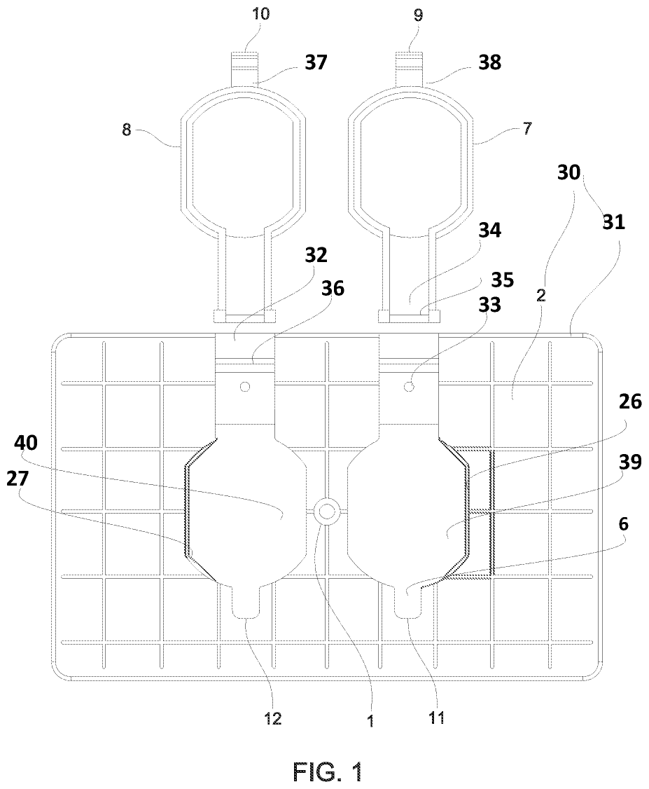

FIG. 1 shows a front view of the outlet cover [30] with a gateway door in an accessible position. The outlet cover [30] is made of a plate [2] and a frame [31]. In addition, the plate has a central balancer [1], a central hole, that assists the outlet cover in securely and stably attaching to a wall with the electric outlet. The plate [2], has at least one circuit bracer [26] and [27], and the bracer is located on at least the first outer side of the gateway [26] and the second outer side bracer [27]. The bracer is located on the outer end and inward (towards the backside) of the gateway opening [39] [40] and stabilizes the outlet cover when in use and is attached to the wall. The accessible gateway also has a connection [32] to the frame [31] with a pressure-sensitive movable button [33]. Each accessible gateway door has an eye [5] [6] that has a catcher [11][12] at one first end that allows the gateway doors to close and lock in an inaccessible position. The second end of the eye is connected to the gateway opening [39][40]. The outlet cover further has a secure portal system with at least one accessible-inaccessible gateway, in this example, two accessible gateways doors [7] and [8] with at least one hook [9] and [10] for each eye [5] and [6]. The hook has two ends, the first end is a trap [9] [10] for the catcher and the second end [37] [38] is connected to the gateway door referred to herein as a door handle. The hook and eye fit to close and lock the accessible gateway into an inaccessible gateway when the outlet cover is attached to the wall but not in use. The movable-button [33] is shielded, covered, overlaid by the hinged-link [34] when the gateway door is inaccessible or closed. The gateway opening [39][40]has an opening-link [32] to the frame through opening-hinged part [36], and the gateway door hinge [34] is connected to a part of the opening-link [36] and a part of the hinged link [35].

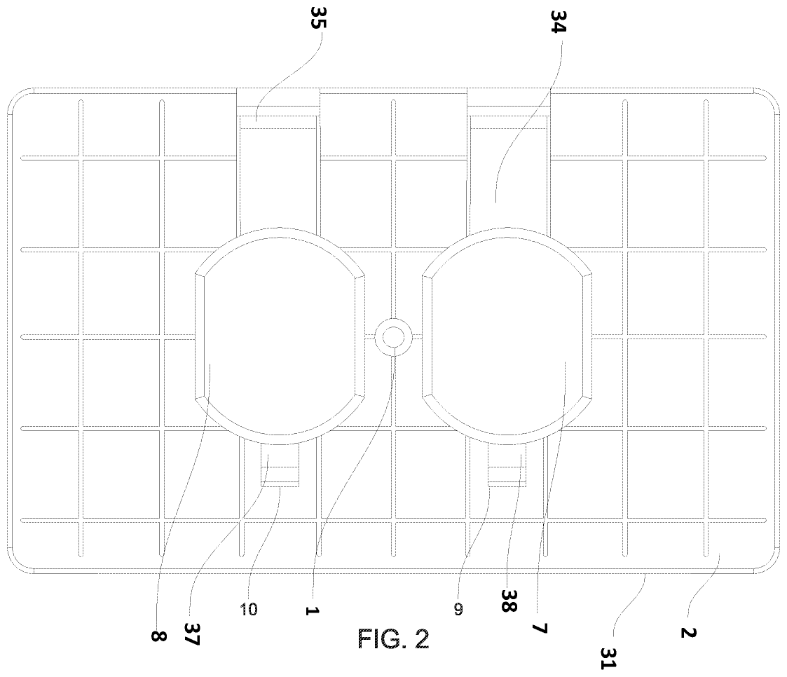

FIG. 2 shows a front view of the outlet cover [30] with a gateway door in an inaccessible position. The gateway doors are closed and locked [7] [8]. This view better depicts the parts of the hook [9] and [10] for each eye [5] and [6]. The hook has two ends, the first end is a trap [9] [10] for the catcher, and the second end [37] [38] is connected to the gateway door referred to herein as a door handle. Shown herein is the hook and eye fit together to close and lock the accessible gateway into an inaccessible gateway. The movable button [33] is shielded or covered by the hinge [34]; hence this movable button is not visible in this view as the gateway door is inaccessible or closed.

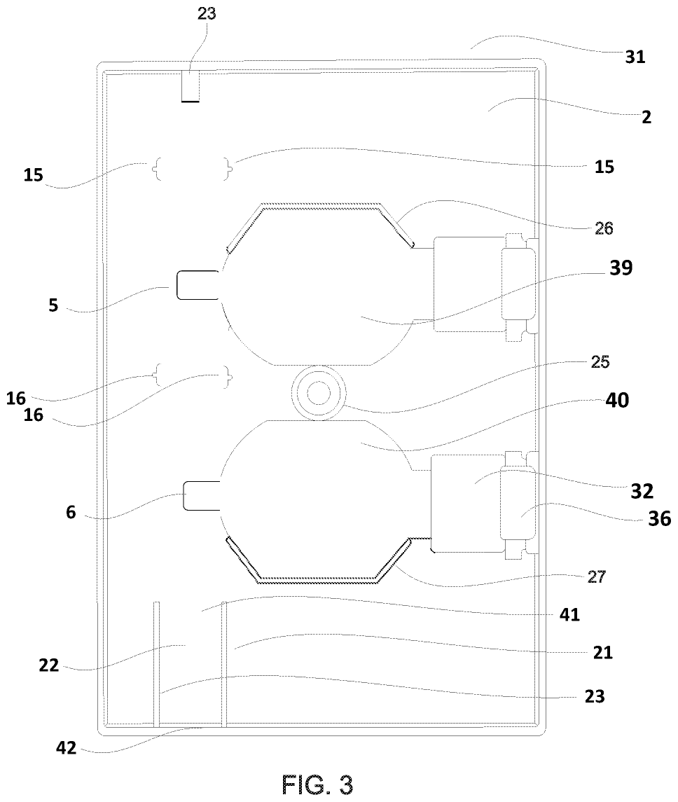

FIG. 3 shows a back view of the outlet cover [30] with a gateway door in an accessible position. The back view of the gateway openings [39][40] with the bracers outwards (coming towards the backside of the plate). The clips [15] [16] are for securely placing the device containing a pressure-creating, pressure-detecting, pressure-transmitting device, lockable system, and an enterable tunnel [22] made of two walls [21] [22] with a first end [41] and a second end [42], wherein the second end is available for the pressure-modulating tool to enter the tunnel [42], and the pressure-creating device is at a first end [41] of an enterable tunnel. The opening link [32] is connected to the opening hinge [36], wherein the hinge may be attached to the gateway door. The opening link [32] contains the pressure-sensitive mechanism for the movable button that can move the button perpendicularly to the plate in response to changes in pressure. The opening link may also include a pressure device or parts thereof. The backside of the balancer is [25].

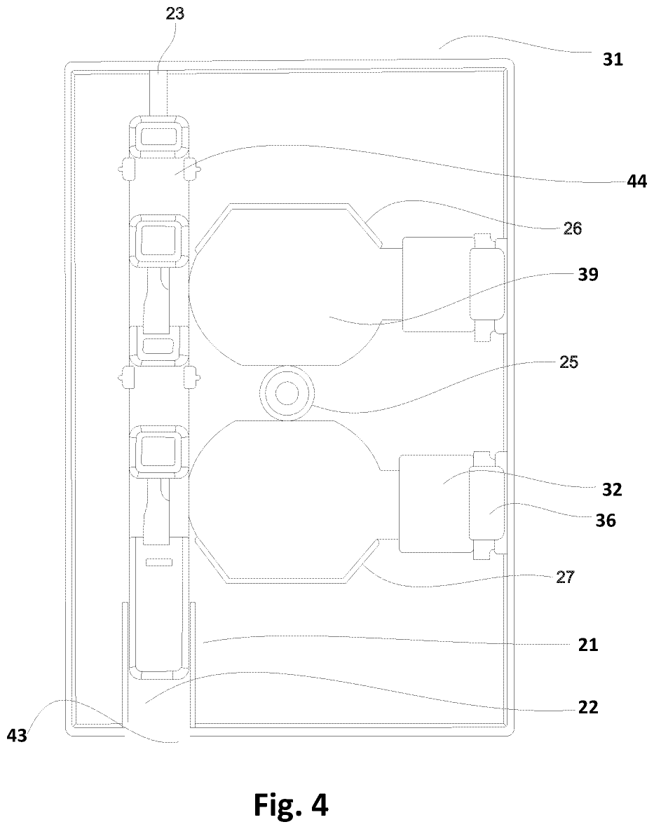

FIG. 4 shows a back view of the outlet cover [30] with a gateway door in an accessible position with a pressure-creating device, a pressure-detecting device, and a pressure-transmitting device [44]. The entryway [43] for the tunnel entrance may be hidden or visible (hidden as shown herein).

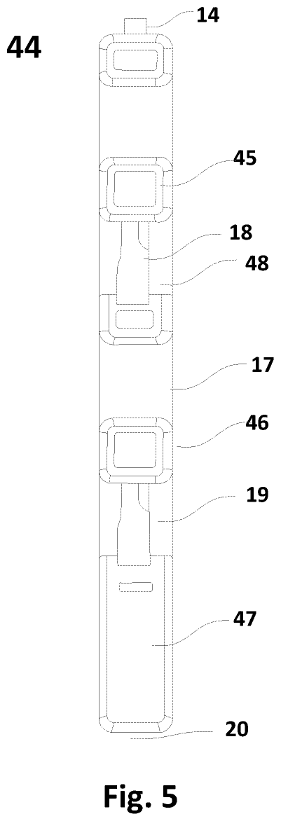

FIG. 5 shows a pressure device and lockable system: The pressure device is made of a pressure-creating device [14], a pressure-modulation device [20] and a pressure-transmitting device [47]. These parts of the pressure device may be arranged and organized in several different ways. Furthermore, the pressure-creating device may be held or connected to a clip [14]. The lockable system has a hook with hook-trap [10], hook handle [37], an eye [5] with an eye-catcher [12] and inner eye-catcher [45][46], a trap body [17], a hook-catcher inside hook entrance [18], and a pressure sensitive movable button [33]. When the hook trap snaps into the inside eye-catcher [45][46], the gateway door/s is unlocked position. The trap body [17] allows the hook-trap from the hook and door handle [10][37] to snap the lock into its body [17]. The hook catcher is located inside the hook entrance, and hooks lock into the trap body [19][48]. When a pressure-modulating tool is inserted into the tunnel, the pressure-modulation device [20] alters (reduces) the pressure of the pressure-creating device (or releases the spring in some embodiments) [14], causing unleashing of hook-trap from the inner eye-catcher [45], which allows the hook trap to become unleashed or unlocked. When the hooks are unleashed, the gateway door opens.

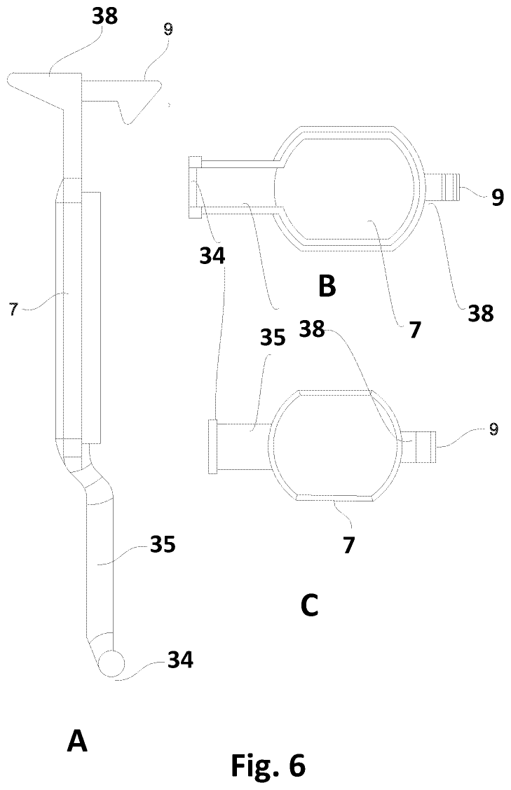

FIG. 6 shows gateway door views.

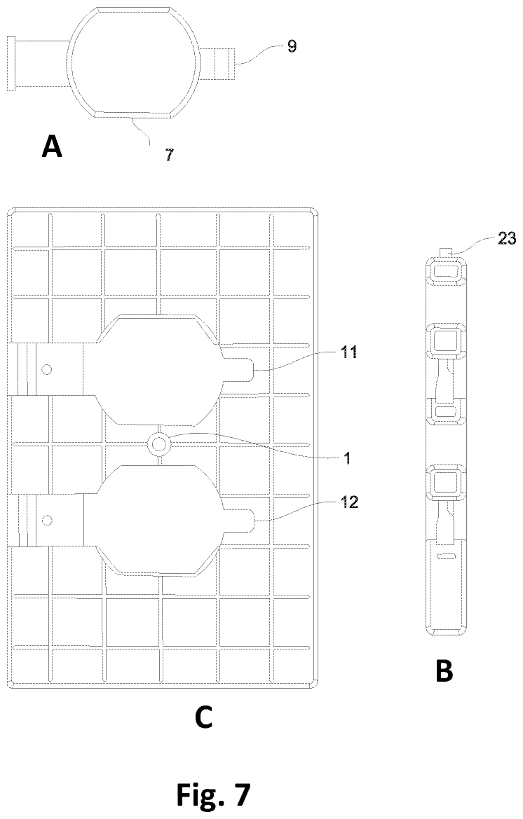

FIG. 7 shows all components of the apparatus.

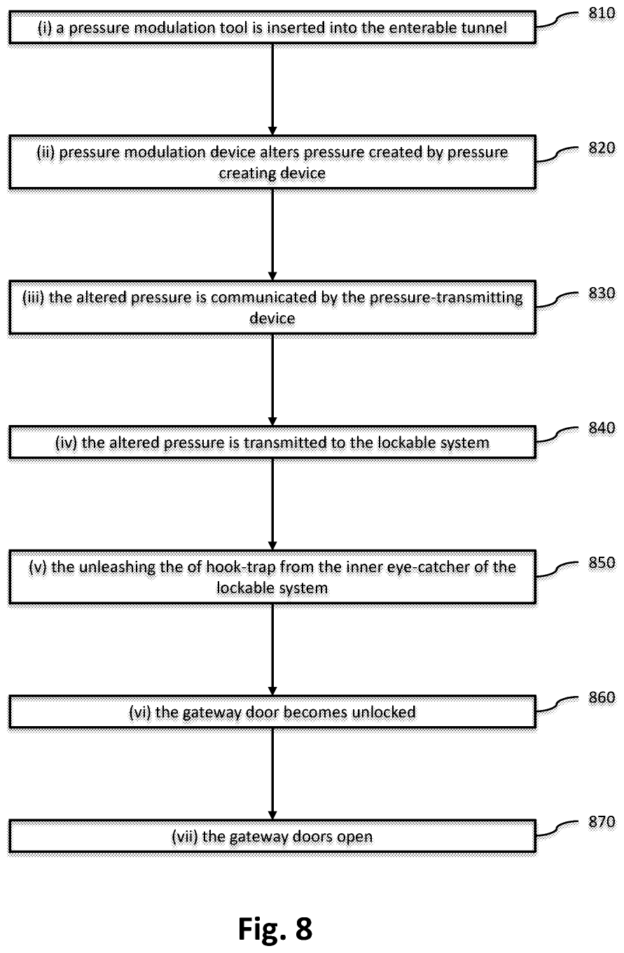

FIG. 8 is a flowchart of an example method for covering electric outlets comprising a cover and at least one secure portal system, wherein the cover is detachably attached to the electrical outlet; wherein the secure portal system comprises at least one accessible-inaccessible gateway with a lockable system, a pressure device, and an enterable tunnel, and comprising of steps:

At step 810, (i) a pressure modulation tool is inserted into the enterable tunnel,

At step 820, (ii) the pressure modulation device alters pressure created by pressure creating device,

At step 830, (iii) the altered pressure is communicated by the pressure-transmitting device,

At step 840, (iv) the altered pressure is transmitted to the lockable system,

At step 850, (v) the unleashing of the hook-trap from the inner eye-catcher of the lockable system, At step 860, (vi) the gateway door becomes unlocked, and

At step 870, (vii) the gateway doors open.

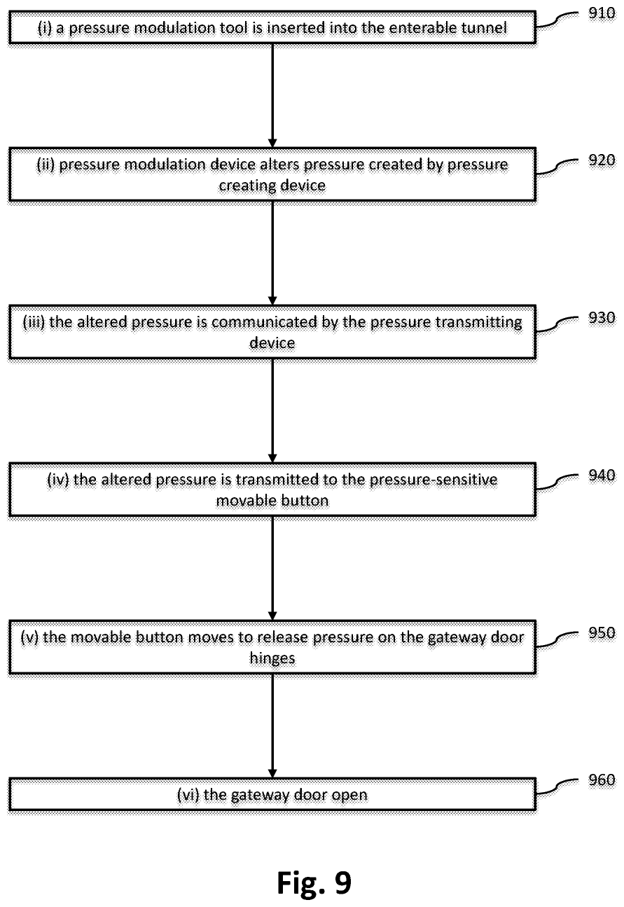

FIG. 9 is a flowchart of an example method for covering electric outlets comprising a cover and at least one secure portal system, wherein the cover is detachably attached to the electrical outlet; wherein the secure portal system comprises at least one accessible-inaccessible gateway with a lockable system, a pressure device, and an enterable tunnel, and comprising of steps:

At step 110, (i) a pressure modulation tool is inserted into the enterable tunnel,

At step 120, (ii) the pressure modulation device alters pressure created by pressure creating device,

At step 130, (iii) the altered pressure is communicated by the pressure transmitting device,

At step 140, (iv) the altered pressure is transmitted to the pressure-sensitive movable button,

At step 150, (v) the movable button moves to release pressure on the gateway door hinges, and

At step 160, (vi) the gateway door open

It is to be understood that the above description is intended to be illustrative and not restrictive. For example, the above-described embodiments (and/or aspects thereof) may be used in combination with each other. In addition, many modifications may be made to adapt a particular situation, method, system device or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements or steps that do not differ from the literal language of the claims, or if the examples include equivalent structural elements or steps with insubstantial differences from the literal language of the claim.

1. An apparatus for covering electric outlets comprising a cover and at least one secure portal system, wherein the cover is detachably attached to the electrical outlet; wherein the secure portal system comprises at least one accessible-inaccessible gateway, at least one lockable system, a pressure device, and an enterable tunnel.

2. The apparatus of claim 1, wherein the apparatus can replace a conventional electrical outlet.

3. The apparatus of claim 1, wherein the pressure device comprises a pressure-creating device, a pressure-modulation device, a pressure-modulating tool, and a pressure-transmitter device.

4. The pressure device of claim 3, wherein the pressure-creating device may be a mechanical compression spring made of a music wire with 12.5 total coils and closed ends, an O.D. of 0.188 inches, an I.D. of 0.154 inches, and a spring rate of 2.3-inch pounds.

5. The apparatus of claim 1, wherein the cover comprises a frame, a plate, a centrally located balancer, and at least one circuit bracer, and wherein the bracer is located on at least one side of the gateway.

6. The cover of claim 5, wherein the bracer fits with any conventional outlet socket, wherein the bracer is configured to attach the cover stably and securely to a wall electrical outlet.

7. The cover of claim 5, wherein the balancer is configured to attach stably and securely the cover to any electric wall outlet, wherein the balancer is configured for correct electrical circuit function without disruption of the electrical circuit.

8. The cover of claim 5, wherein the balancers contain a 0.5-inch long balancer screw within it centrally.

9. The apparatus of claim 1, wherein the lockable system comprises at least one hinge, at least one hinge-link, at least one hook-trap, at least one hook-handle, at least one eye, at least one eye-catcher, at least one inner eye-catcher, and at least one pressure-sensitive movable button, wherein the hinge, when the accessible-inaccessible gateway door is in an inaccessible position, over lays and pushes down the pressure-sensitive movable button.

10. The lockable system of claim 9, wherein the pressure-sensitive movable button is within an opening link.

11. The apparatus of claim 1, wherein the enterable tunnel has two ends, a first end and a second end, wherein the first end has an opening to the enterable tunnel, and the second end has the pressure-modulating device.

12. The apparatus of claim 1, wherein the enterable tunnel is available for the pressure-modulating tool to enter the tunnel to alter/reduce the pressure-creating device's pressure through the pressure-modulating device.

13. The apparatus of claim 1, wherein the pressure device comprises a pressure modulation device connected to a pressure transmitter device, wherein the pressure transmitter device communicates an alternation in pressure, wherein the communication is selected from a group consisting of mechanical, analog, digital, wired, wireless, and any combination thereof.

14. The pressure device of claim 13, wherein the pressure transmitter device communicates an alternation in pressure to a pressure-sensitive movable button of the lockable system.

15. The apparatus of claim 13, wherein the pressure transmitter device communicates an alternation in pressure to the lockable system.

16. The apparatus of claim 1, wherein the pressure-creating device is connected to a lockable system, wherein the pressure modulation tool through the tunnel is configured to modulate the pressure of the pressure-creating device, wherein the pressure-creating device transmits pressure alternations to the lockable system, and wherein the lockable system is further configured to open the inaccessible, locked gateway door.

17. The secure portal of claim 1, wherein the pressure modulation tool through the tunnel is configured to modulate the pressure generated by the pressure-creating device, wherein the pressure-creating device transmits pressure any pressure alternations to the pressure-sensitive movable button, and wherein the movable button is further configured to open the locked accessible-inaccessible gateway door.

18. The apparatus of claim 1, wherein the apparatus has a light-sensitive and motion-sensitive LED electrical light bulb, wherein a battery powers the bulb.

19. A method for covering electric outlets comprising a cover and at least one secure portal system, wherein the cover is detachably attached to the electrical outlet; wherein the secure portal system comprises at least one accessible-inaccessible gateway with a lockable system with an inner eye-catcher, a pressure device, and an enterable tunnel, and comprising of steps:
(i) a pressure modulation tool is inserted into the enterable tunnel,
(ii) pressure modulation device alters pressure created by pressure creating device,
(iii) the altered pressure is communicated by the pressure-transmitting device,
(iv) the altered pressure is transmitted to the lockable system,
(v) the unleashing of the hook-trap from the inner eye-catcher of the lockable system,
(vi) the gateway door becomes unlocked, and
(vii) the gateway doors open.

20. A method for covering electric outlets comprising a cover and at least one secure portal system, wherein the cover is detachably attached to the electrical outlet; wherein the secure portal system comprises at least one accessible-inaccessible gateway with a lockable system with pressure-sensitive movable button, a pressure device, and an enterable tunnel, and comprising of steps:
(i) a pressure modulation tool is inserted into the enterable tunnel,
(ii) pressure modulation device alters pressure created by pressure creating device,
(iii) the altered pressure is communicated by the pressure transmitting device,
(iv) the altered pressure is transmitted to the pressure-sensitive movable button,
(v) the movable button moves to release pressure on the gateway door hinges, and
(vi) the gateway door open.
